(19) United States
(12) Patent Application Publication
(10) Pub. No.: US 2014/0062836 A1
(43) Pub. Date: Mar. 6, 2014

(54) VIDEO DISPLAY MODULE, SPLINE AND VIDEO DISPLAY ARRAY STRUCTURE USING SAME

(71) Applicant: REVOLUTION DISPLAY, Glendale, CA (US)

(72) Inventors: Andrew HYMAN, Waltham, MA (US); Matthew WARD, Philadelphia, PA (US)

(73) Assignee: REVOLUTION DISPLAY, Glendale, CA (US)

(21) Appl. No.: 14/018,220

(22) Filed: Sep. 4, 2013

Related U.S. Application Data
(60) Provisional application No. 61/696,617, filed on Sep. 4, 2012.

(51) Int. Cl. G06F 3/14

(52) U.S. Cl. CPC G06F 3/1446
USPC 345/1.3

(57) ABSTRACT

Disclosed is a video display array structure comprising at least two spaced apart splines having a plurality of opposing pairs of catches regularly spaced along the opposing sides of adjacent splines and a latch notch for each pair of catches and a video display module releasably mounted between the at least two splines, the video display module including first and second handles rotatable between an open and a locked position for releasably mounting the video display to a spline.

### RELATED APPLICATION

This application claims priority to U.S. Provisional Application Ser. No. 61/696,617, filed Sep. 4, 2012, entitled “VIDEO DISPLAY MODULE, VIDEO DISPLAY ARRAY STRUCTURE AND METHOD OF MAKING SAME,” the entirety of which is incorporated herein by this reference.

### BACKGROUND

1. Field

This invention relates to the mechanical and electrical arts. In particular, it relates to a video display module, a spline and video display array structure formed from same.

2. Discussion of the Related Art

Conventional modular display systems used in the large screen display industry involve combining individual video display units, such a as LED panels or LCD monitors, into large and generally seamless video display array structures. There are two conventional approaches to the assembly of such structures. Both approaches include manual-locking and auto-locking mechanisms that allow the attachment of video display modules to adjacent modules or to a secondary frame. In one approach, video display modules are secured directly to adjacent video display modules. In the second approach, often used with LED displays, the video display modules are secured to an external frame. Early systems for use with LED display modules used simple rigging systems and cam locks. Loose pins would lock the units together. Modern LED display modules can include complicated integral lock systems.

A drawback, to both approaches is that they require manual labor and the multi-step construction process is complicated and difficult. Accordingly, there is a definite need for video display modules that can that can be simply and ergonomically assembled into video display array structures and then simply and ergonomically disassembled, if desired.

### SUMMARY OF THE INVENTION

Now in accordance with the invention there has been discovered a video display module, a spline and a video display array structure combining the video display module and spline that overcome this and related disadvantages. In one aspect, the video display module comprises a video display unit and a video display housing having a front surface and opposing first and second sides supporting the video display unit. In a further aspect, a first handle is attached to the top surface of the first side of the video display housing. The first handle has first and second opposing sides with a first latch extending from the first side of the first handle and the first handle is rotatable between an open and a locked position. And in a further aspect, a second handle is attached to the top surface of the second side of the video display housing. The second handle has first and second opposing sides with a second latch extending from the first side of the second handle and the second handle is rotatable between an open and a locked position:

In one aspect, the video display housing includes a first release and a second release for releasing the first and second handles from their locked positions, respectively. In a further aspect, the first handle is attached by a first two-position hinge operably connected to the first release and the second handle attached by a second two-position hinge operably connected to the second release And in one aspect, the releases include a trigger release disposed on the handle.

In one aspect, the video display unit is an LED display or an LCD display.

In one aspect, the housing has a polygonal shape and in one aspect, the polygonal shape is a rectangle or a square. In some embodiments, the first handle and the second handle are attached at the same distance along the first and second opposing sides of a rectangular or square housing.

In another aspect, the spline comprises a substantially linear member having first and second opposing sides. In further a aspect, a plurality of pairs of catches are regularly spaced along on at least one of the opposing sides of the linear member. And in a still further aspect, the spline includes a latch notch for each pair of catches, where each latch notch is disposed above the pair of catches and extends the distance between the catches in each pair.

In some embodiments, the substantially linear member comprises a central portion having a top portion and at least one catch flanges extends transversely from the top of the central portion, wherein the at least one flange has a lower edge and wherein the plurality of pairs of catches extend outwardly from the lower edge.

In still another aspect, the video display array structure comprises at least two spaced apart splines, where each spline has first and second opposing sides, with a plurality of opposing pairs of catches regularly spaced along the opposing sides of adjacent splines and with a latch notch for each pair of catches, where each latch notch is disposed above the pair of catches and extends the distance between the catches in each pair.

In one aspect, a video display module is releasably mounted between the at least two splines. And in one aspect, the video display module comprises a video display unit and a video display housing having a front surface and opposing first and second sides supporting the video display unit. In a further aspect, a first handle is attached to the top surface of the first side of the video display housing. The first handle has first and second opposing sides with a first latch extending from the first side of the first handle. In some aspects, the first handle is rotatable between an open and a locked position and the first latch is aligned with a pair of catches on one of the sides of one of the spaced apart splines for releasably mounting the video display to a spline And it the further aspect, a second handle is attached to the top surface of the second side of the video display housing. The second handle has first and second opposing sides with a second latch extending from the first side of the second handle. In some aspects, the second handle rotatable between an open and a locked position and the second latch aligned with a pair of catches on the opposing side of the adjacent releasably mounting the video display to the adjacent spline.

In one aspect, the video display housing includes a first release and a second release for releasing the first and second handles from their locked positions, respectively. In a further aspect, the first handle is attached by a first two-position hinge operably connected to the first release and the second handle attached by a second two-position hinge operably connected to the second release And in one aspect, the releases include a trigger release disposed on the handle.

In one aspect, the video display unit is an LED display or an LCD display.

In one aspect, the housing has is a polygonal shape and in one aspect and in one aspect, the polygonal shape is a rectangle or a square. In some embodiments, the first handle and the second handle are attached at the same distance along the first and second opposing sides of a rectangular or square housing.

In another aspect, the spline comprises a substantially linear member having first and second opposing sides. In further a aspect, a plurality of pairs of catches are regularly spaced along on at least one of the opposing sides of the linear member. And in a still further aspect, the spline includes a latch notch for each pair of catches, where each latch notch disposed above the pair of catches and extending the distance between the catches in each pair.

In some embodiments, the substantially linear member comprises a central portion having a top portion and at least one catch flange extending transversely from the top of the central portion, wherein the at least one flange has a lower edge and wherein the plurality of pairs of catches extend outwardly from the lower edge.

In one aspect, the video display module of claim wherein the splines are of equal length and the pairs of catch members on each of the opposing sides of the splines are spaced the same distance along the length of each spline. And in one aspect, the spacing between adjacent pairs of catch members is substantially the same as the height of adjacent video display modules. And in a further aspect, the video display module further comprises a header to space the splines.

### BRIEF DESCRIPTION OF THE DRAWINGS

FIG. 1 is a front elevational view of a video display array structure in accordance with one embodiment of the invention.

FIG. 2 is a back elevational view of the video display array structure of FIG. 1.

FIG. 3 is an exploded perspective view of one embodiment of a portion of a video display array structure in accordance with one embodiment of the invention.

FIG. 4 is a perspective view of a portion of a spline, including a pair of catch members and a latch notch, in accordance with one embodiment of the invention.

FIG. 5 is a perspective view of a portion of a video display module, including a handle, in accordance with one embodiment of the invention.

FIGS. 6A and 6B are perspective views of a portion of a video display array structure, in accordance with the embodiments of FIGS. 4 and 5, shown in open and locked positions, respectively.

FIGS. 7A-F represent a method of assembling a video display array structure in accordance with one embodiment of the invention.

### DETAILED DESCRIPTION OF THE PREFERRED EMBODIMENTS

Particular embodiments of the invention are described below in detail for the purpose of illustrating its principles and operation. However, various modifications may be made, and the scope of the invention is not limited to the exemplary embodiments described below.

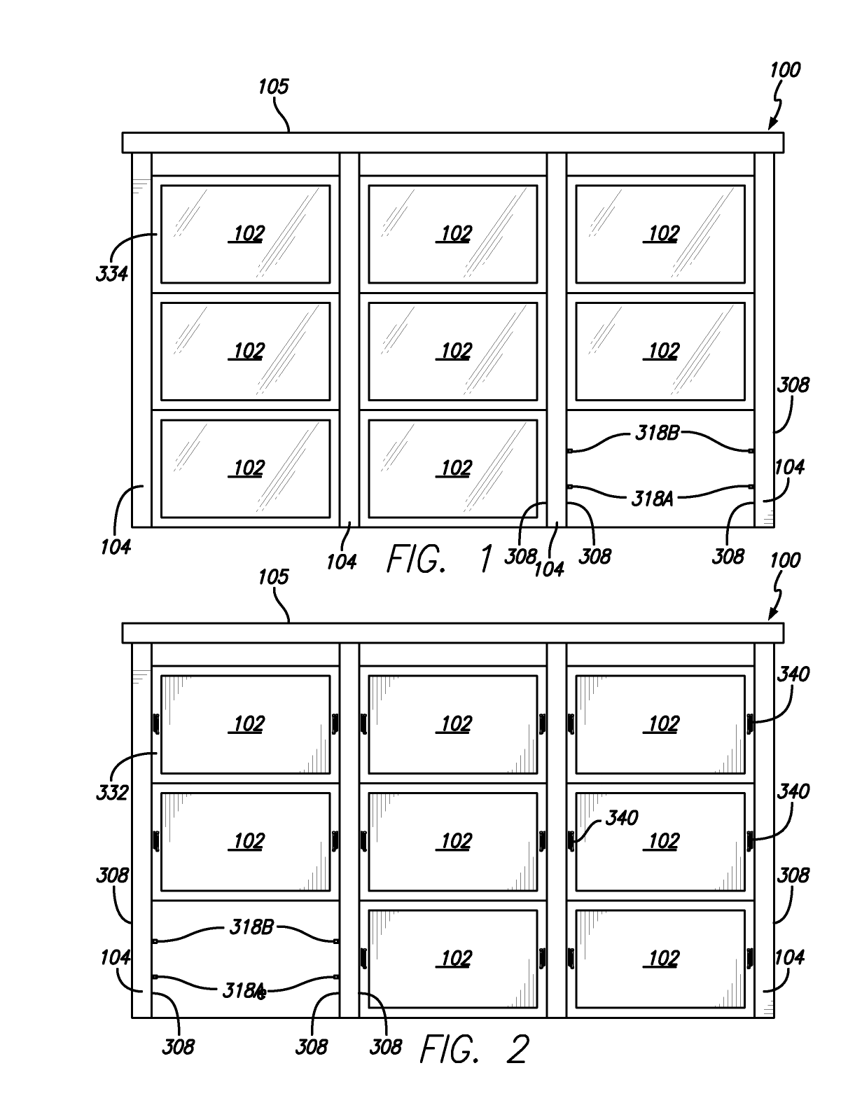

FIGS. 1 and 2 are front and back elevational views of a video display array structure 100 in accordance with one aspect of the invention. Shown is a three-by-three array of video display modules 102, with one video display module removed in each array. However, it will be readily be understood by one skilled in the art that video display modules can be assembled into columns, rows or a matrix of both and may include any desired number of video display modules.

In the embodiment shown in FIGS. 1 and 2, the video display modules 102 are supported on a plurality of splines 104 spaced apart by a header 105. In the embodiment shown in FIGS. 1 and 2 three columns of video display monitors are supported between four splines. However, it is an aspect of the invention that n video display monitors can be supported between n plus 1 splines. Furthermore, in the embodiment shown in FIGS. 1 and 2, the splines are vertically oriented and are spaced apart using the horizontally oriented header. It is an aspect of the invention that the splines can have a horizontal or other orientation and be spaced apart using one or more suitable spacers. The splines and the spacer can be made of any suitable material, such as metal or engineering plastic. In some embodiments, the spline and spacers are made of aluminum.

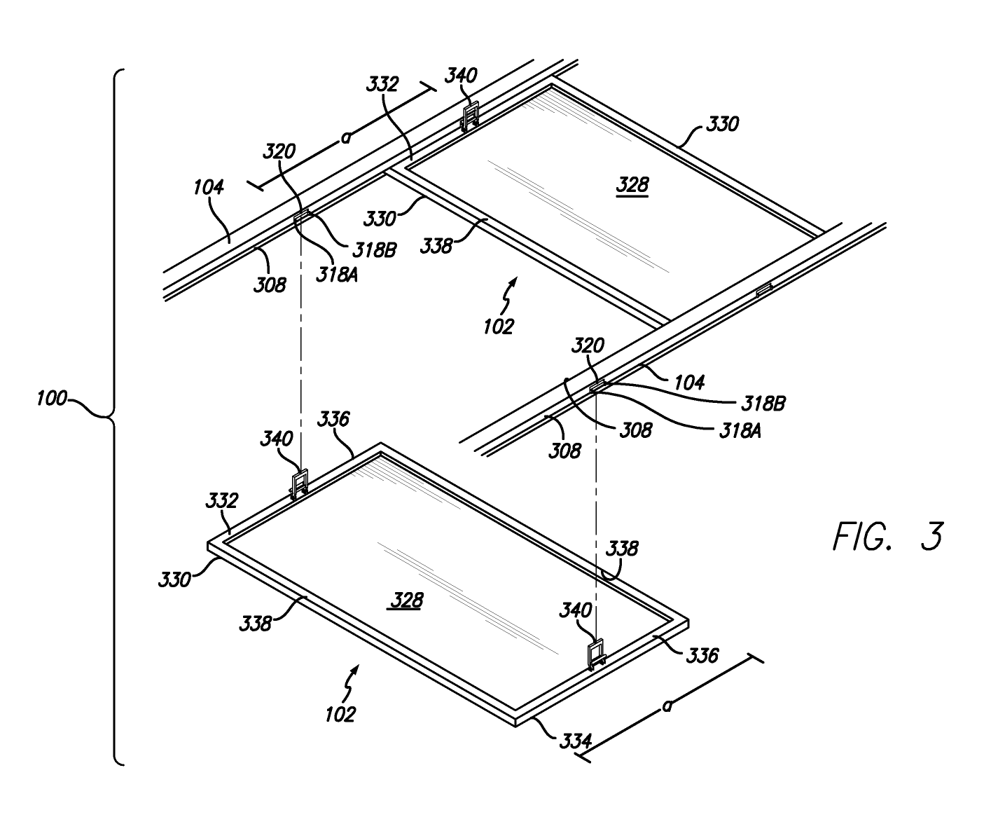

FIG. 3 is a partially exploded perspective view of one embodiment of a portion of a video display array structure 100. The structure includes a pair of opposing splines 104 supporting adjacent video display modules 102. In the embodiment shown in FIG. 3, the splines are comprised of substantially linear members with opposing sides 308 on adjacent splines. In one aspect, extending from each of the opposing sides is at least one catch for releasably securing each video display monitor supported by the splines. In one aspect, the catches are regularly spaced along each of the opposing sides. Shown in the representative embodiment of FIGS. 1-3 is a single pair of spaced apart catches 318A and 318B on each of the opposing sides, for each video display module to be secured. In alternative embodiments, two or more pairs of catches are regularly spaced along each of the opposing sides, for each video display module to be secured.

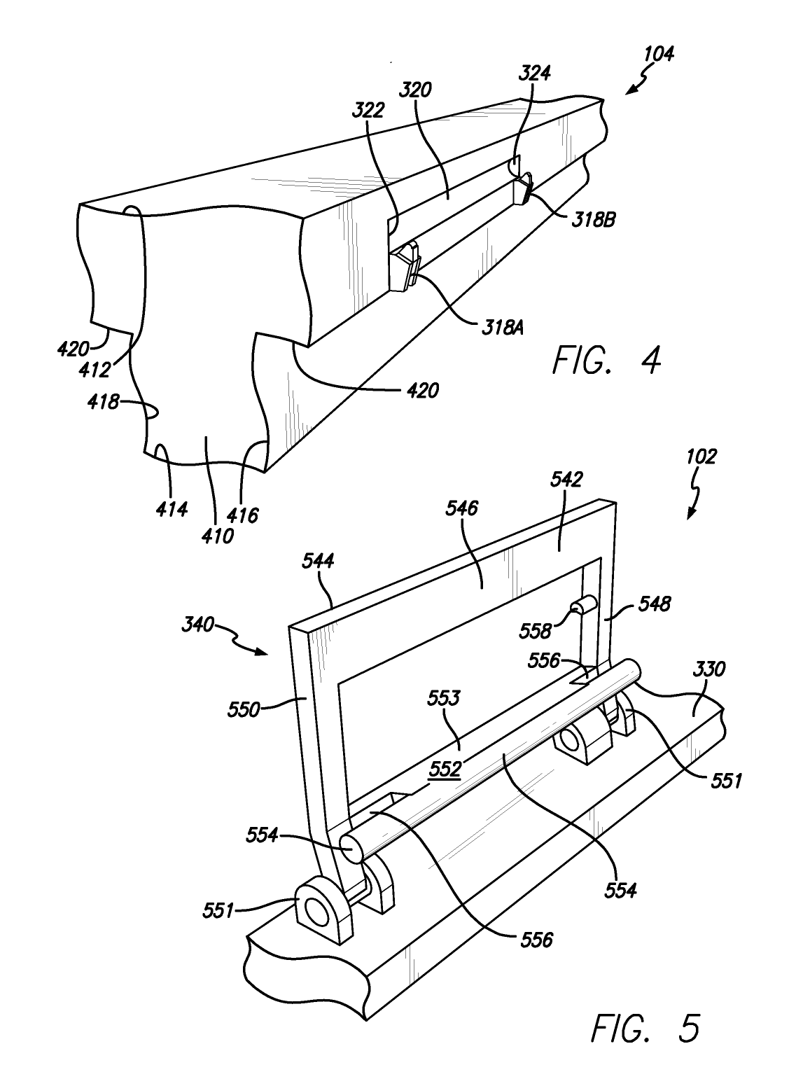

Additionally in some embodiments, at least one latch notch 320 extends longitudinally along a portion of each of the sides 308 of the splines 104 for each video display module to be secured. As best seen in FIG. 4, in some embodiments, the latch notch has first and second opposing ends, 322 and 324, respectively, and a catch member 318A from each of the sets is disposed below the first opposing end and the other catch members 318B is disposed below the second opposing end.

As best understood in connection with FIGS. 1 and 2, in some embodiments, adjacent pairs of catch members are spaced apart from one another a sufficient distance to provide that the video display monitors can be positioned adjacent to one another. In some embodiments, the catch members are spaced apart a distance to provide that the adjacent video display monitors abut one another. For example, as shown in FIG. 3, if adjacent video display monitors both have the height “a”, the distance between adjacent catch members and the latch notches is also “a”.

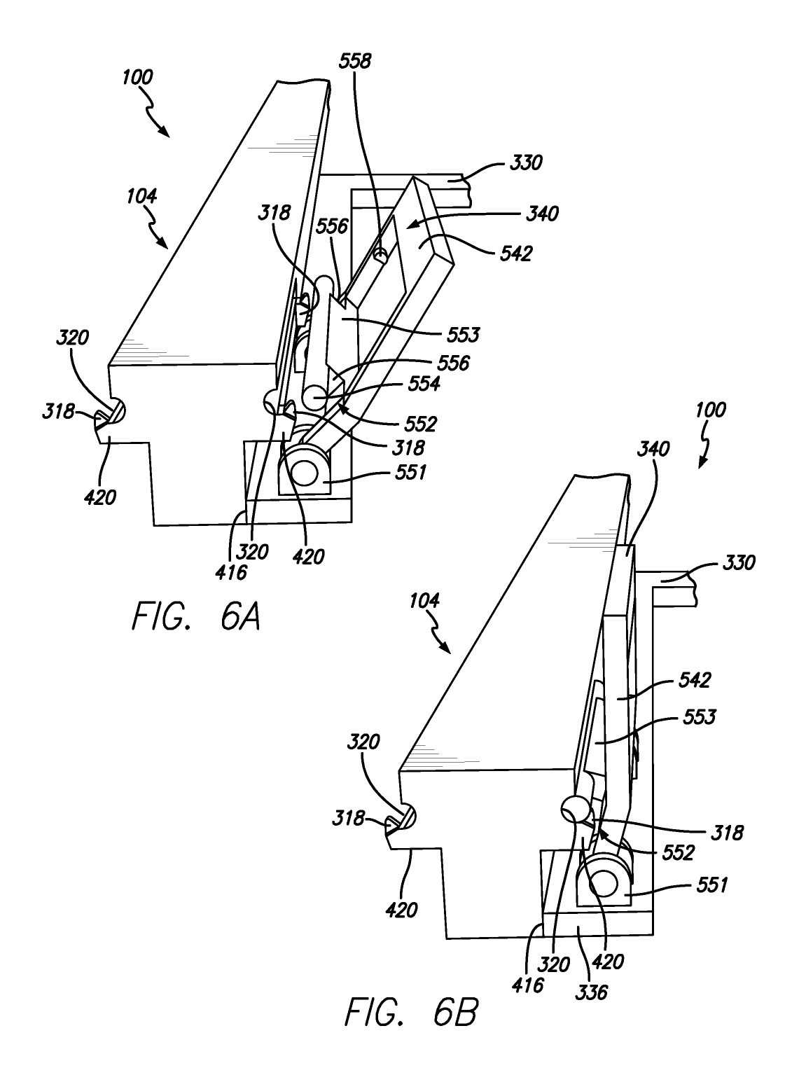

Turning additionally to FIG. 4, there is shown a perspective view of a portion of one embodiment of a portion of a spline 104 having a T-shaped cross-section. The spline has a central portion 410 having a top 412, a bottom 414, a first side 416 and an opposing second side 418. In the embodiment shown in FIG. 4, catch flanges 420 having a top edge and a lower edge extend transversely from the top of the central portion. The pair of the catches 318A and B extend outwardly from each of the flanges (See also FIGS. 6A and 6B) and latch notch is disposed above each pair of the catch members.

Returning to FIG. 3, it can be seen that each of the video display modules 102 includes a video display unit 328 and a video display housing 330 supporting the video display module. It is an advantage of the invention that it can be used with a wide variety of video display units, such as LED panels and LCD displays, and includes transparent video display units. The video display housing 330 can be of any shape suitable for supporting the video display module. In some embodiments, the housing has a polygonal shape and, in some embodiments, the housing has a square or rectangular shape. In the embodiment shown in FIG. 3, the display housing has a rectangular shape, with a top 332 surface and a bottom 334 surface, as well as a first pair of opposing side members 336 and a second pair of opposing side members 338.

In one aspect, disposed on the top of each of the first pair of opposing side members 336 is at least one pair of handles 340. It is an advantage of the invention that the handles provide the dual purposes of handling the video display modules 102, as well as attaching the video display modules to the splines to form the video display array structure 100. In the embodiment shown in FIGS. 1-3, there is a single handle on the top surface 332 of each of the opposing first side members 336, but, in alternative embodiments, more than one handle can be included on each side member. The number of handles and the location required for a particular video display module are dependent on such factors as the weight, dimensions and center of gravity of the video display unit. They will be readily determinable by one skilled in the art without undue experimentation. Each pair of handles 340 is spaced the same distance from each of the second opposing side members 338, so that each handle lies on an axis parallel to the second opposing side members and is aligned with a corresponding pair of catch members 318 and latch notch 320 when the video display unit 102 is brought together with the splines 104 to form part of the video display array structure 100.

Turning additionally to FIG. 5, there is shown a perspective view of a portion of one embodiment of the video display module 102, including the video display housing 330 and the handle 340, with opposing first and second handle side surfaces, 542 and 544, respectively. In the embodiment shown in FIG. 5, the handle includes a grip portion 546 and a pair of arms 548 and 550 extending from the grip portion and attached to the video display housing. In some aspects, the handles are rotatably attached to the top of the video display housing and movable between an open (as best seen in FIG. 6A) and a closed (as best seen in FIG. 6B) position using a pair of two-position hinges 551.

A latch 552 extends outwardly from the first handle side surface 542. In the embodiment shown in FIG. 5, the latch includes a latch flange 553 extending between the arms 548 and 550 and spaced apart from the grip portion 746 and a latch piece 554 attached to distal end of the latch flange. In the embodiment shown in FIG. 5, the latch piece is a cylindrical rod extending longitudinally across the handle. Additionally, in the embodiment shown in FIG. 5, a pair of gaps 556 is formed between the latch flange and the latch piece.

FIGS. 6A and 6B are perspective views of a portion of a video display array structure 100, in accordance with the embodiments of FIGS. 4 and 5, with the handle 340 shown in open and locked positions, respectively. The latch piece 554 is configured so that latch 552 is aligned with the catch members 318 and the latch notch 320 when the side member 336 of video display housing 330 is positioned against the first side 416 of spline 104.

The latch 552 is dimensioned and positioned, so that at least a portion of the latch piece 554 is received by the notch 320 and secured by the catch members 318A and B when the latch in the closed position. Similarly, the gaps 556 are dimensioned and positioned to receive the catch members when the latch is in the closed position.

Returning to FIG. 5, in some embodiments, the handle 340 additionally includes a release 558 operably connected to the two-position hinge 551 for releasing the handle 552 from its locked position. In some embodiments, the release provides two-position mechanical articulation and, in some aspects, the release include mechanically articulated trigger and button releases.

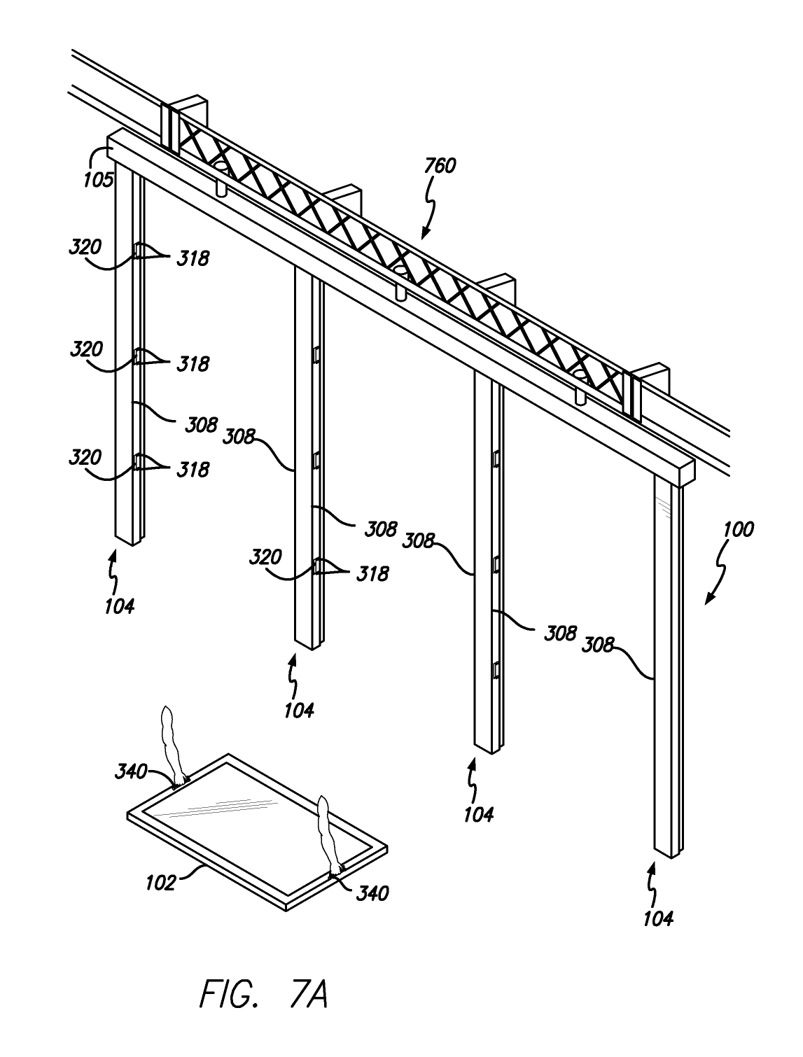

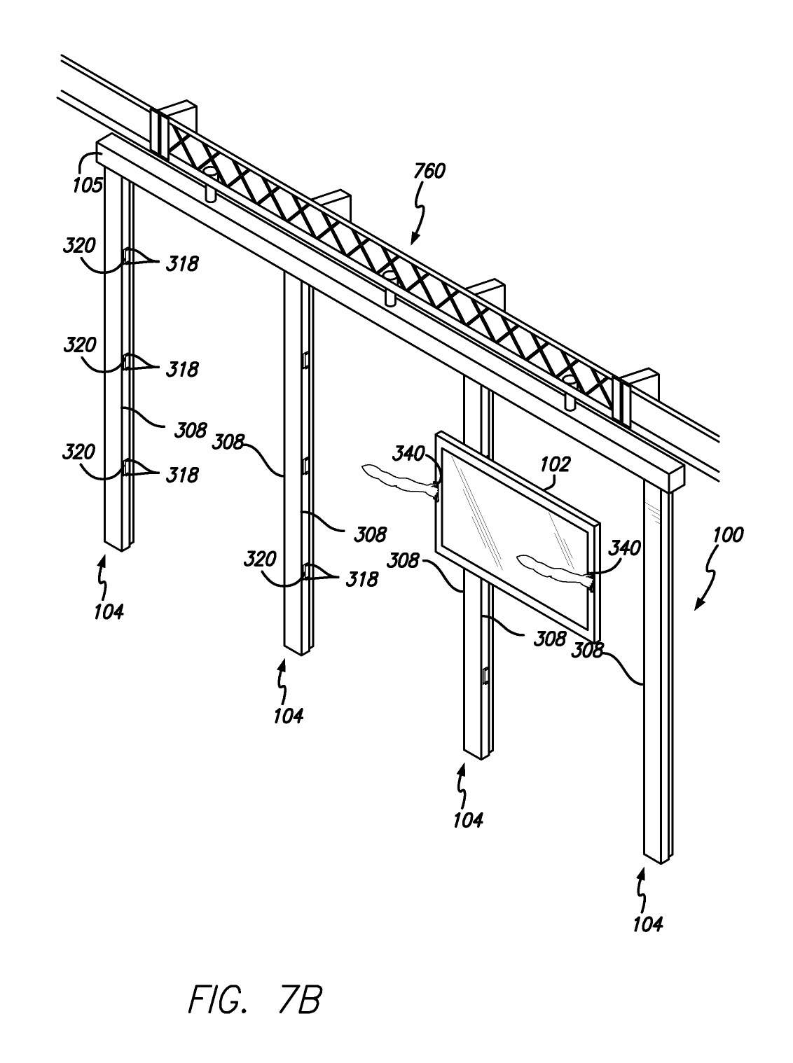

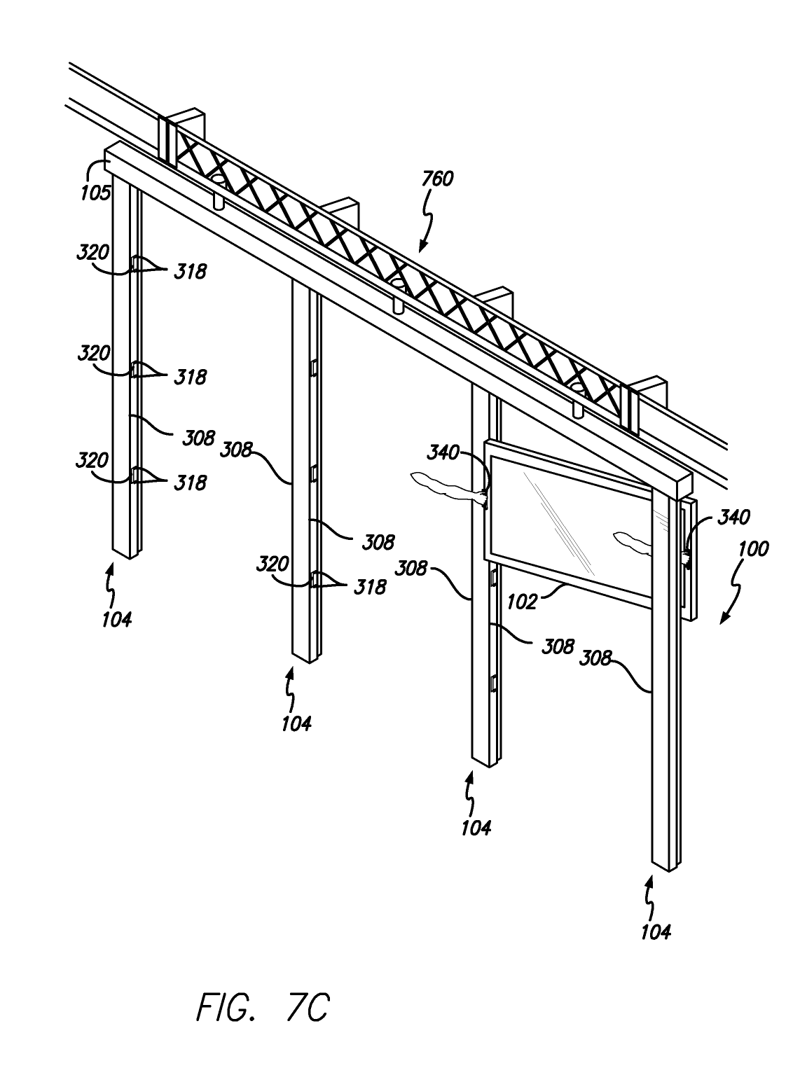

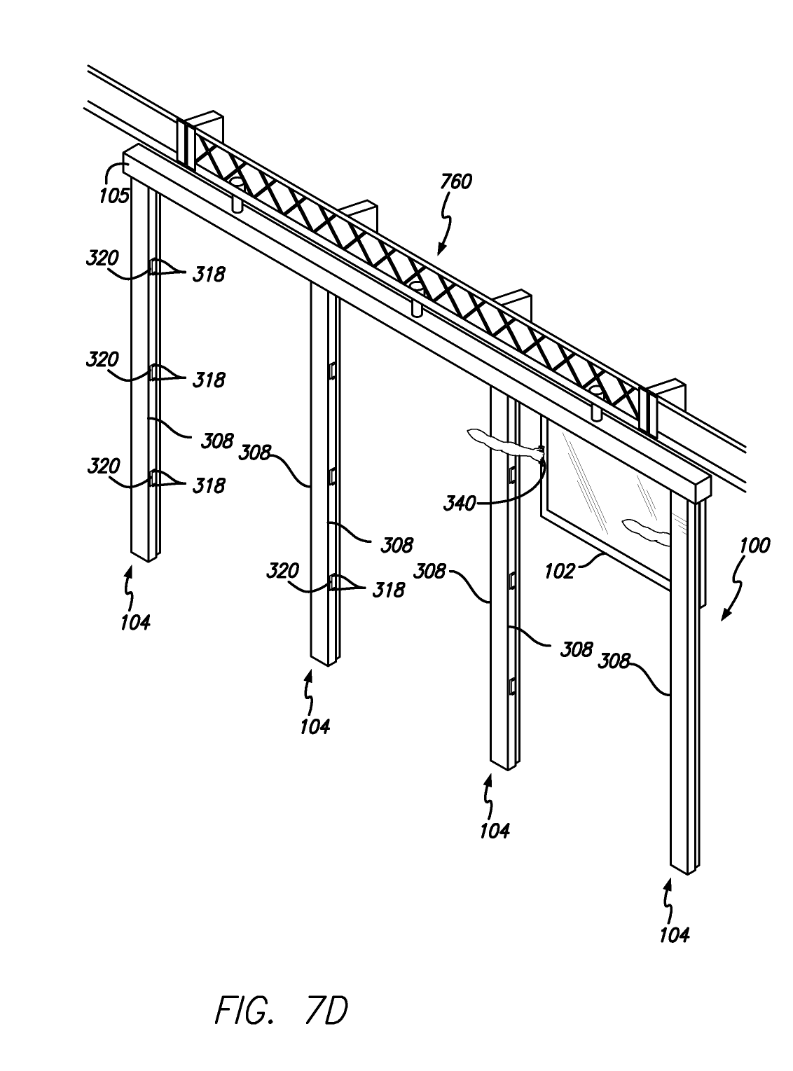

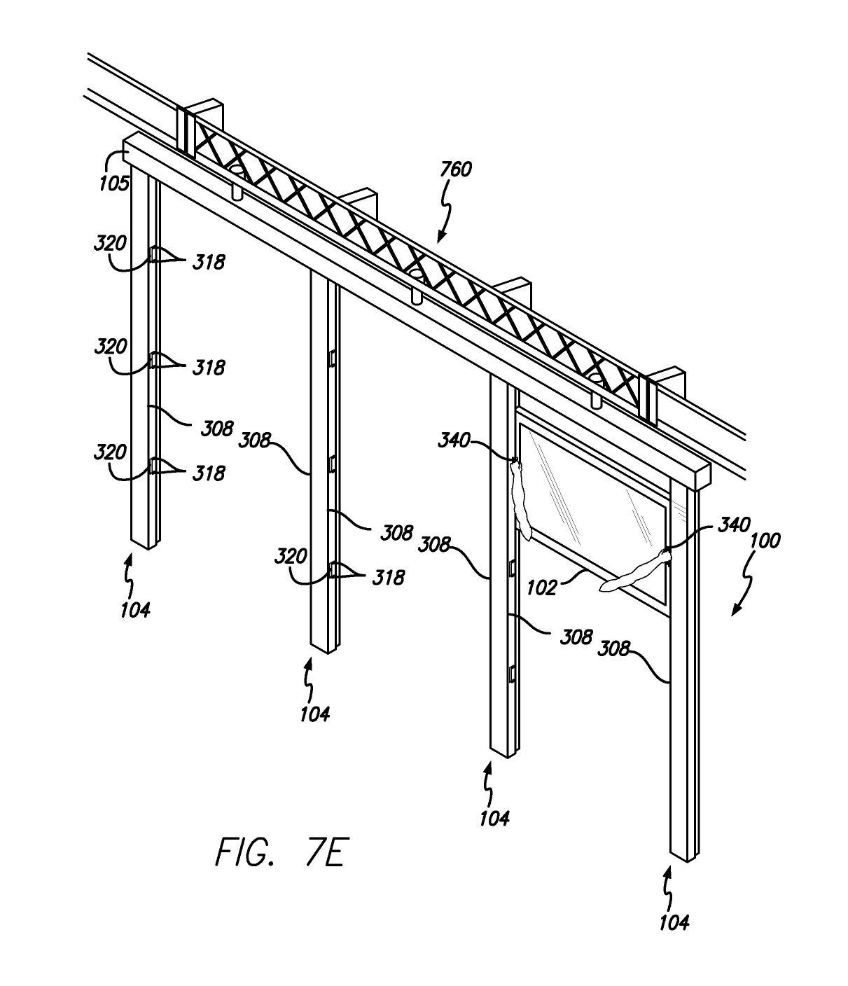

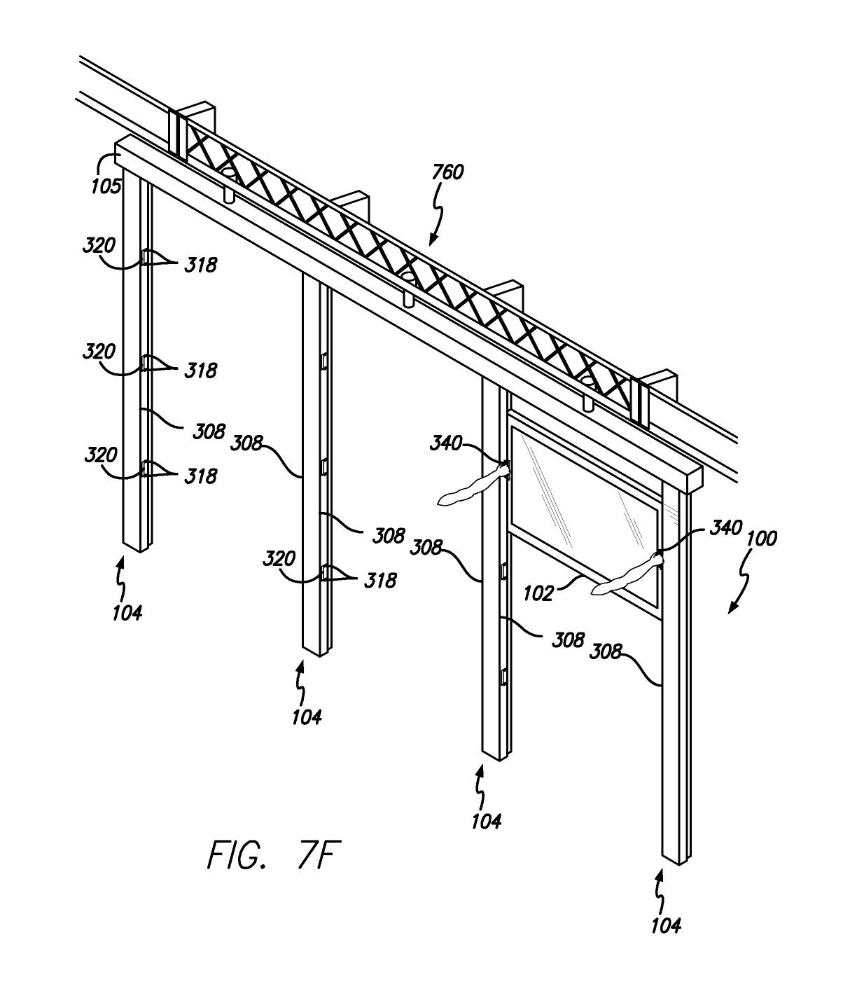

Another aspect of the invention is method for assembling a video display array structure 100 suspended from a rigging 760. FIGS. 7A-F represent one embodiment of such a method. The video display module 102 is lifted using handles 340 in the open position (FIG. 7A). The video display module is then held parallel to the splines 104 to which it is to be secured (FIG. 7B). Then the video display module is passed through the splines by manipulating the angle of the video display module, using a grip on both handles (FIG. 7C). Once the video display module is through the splines, the video display module is again brought into a parallel relationship with the splines (FIG. 7D). The video display module is then pulled back against the splines mating with alignment pins (not shown) to ensure correct positioning (FIG. 7E). Lastly, the handles are rotated to the locked position to secure the video display module to the splines (FIG. 7F).

It is a distinct advantage of the inventive method that all the steps can be accomplished without having a user(s) remove their hands from the initial handle positions. It is a further advantage, that the video display array structure can be simply and easily disassembled, by using the release member to release the handle from the locked position and then reversing the steps shown in FIGS. 7A-F.

We claim:

1. A video display module for a video display array structure comprising:
a video display unit;
a video display housing supporting the video display unit, the video display housing having a front surface and opposing first and second sides;
a first handle attached to the top surface of the first side of the video display housing, the first handle having first and second opposing sides and the first handle rotatable between an open and a locked position,
a first latch extending from the first side of the first handle;
a second handle attached to the top surface of the second side of the video display housing, the second handle having first and second opposing sides and the second handle rotatable between an open and a locked position:
a second latch extending from the first side of the second handle; and
a first release and a second release for releasing the first and second handles from their locked positions, respectively.

2. The video display module of claim 1 wherein the video display unit is an LED display or an LCD display.

3. The video display module of claim 1 wherein the first handle is attached by a first two-position hinge operably connected to the release and the second handle attached by a second two-position hinge operably connected to the second release.

4. The video display module of claim 1 wherein the housing has is a polygonal shape.

5. The video display module of claim 4 wherein the polygonal shape is a rectangle or a square.

6. The video display module of claim 5 wherein the first handle and the second handle are attached at the same distance along the first and second opposing sides, respectively.

7. The video display module of claim 1 wherein the release includes a trigger release disposed on the handle.

8. A spline for a video display array structure, the spline comprising:
a substantially linear member having first and second opposing sides;
a plurality of pairs of catches regularly spaced along at least one of the opposing sides of the linear member, and
a latch notch for each pair of catches, each latch notch disposed above the pair of catches and extending the distance between the catches in each pair.

9. The spline of claim 8 wherein the substantially linear member comprises a central portion having a top portion and at least one catch flange extending transversely from the top of the central portion, wherein the at least one catch flange has a lower edge and wherein the plurality of pairs of catches extend outwardly from the lower edge.

10. A video display array structure comprising:
at least two spaced apart splines, each spline having first and second opposing sides;
a plurality of opposing pairs of catches regularly spaced along the opposing sides of adjacent splines and
a latch notch for each pair of catches, each latch notch disposed above the pair of catches and extending the distance between the catches in each pair;
at least one video display module releasably mounted between the at least two splines, the video display module comprising:
a video display unit;
a video display housing supporting the video display unit, the video display housing having a front surface and opposing first and second sides;
a first handle attached to the top surface of the first side of the video display housing, the first handle having first and second opposing sides and the first handle rotatable between an open and a locked position;
a first latch extending from the first side of the first handle, the first latch aligned with a pair of catches on one of the sides of one of the spaced apart splines, for releasably mounting the video display to a spline;
a second handle attached to the top surface of the second side of the video display housing the second handle having first and second opposing sides and the second handle rotatable between an open and a locked position; and
a second latch extending from the first side of the second handle, the second latch aligned with a pair of catches on the opposing side of an adjacent spaced apart spline for releasably mounting the video display to the opposing spline; and
a release for releasing the first and second handles from their locked positions.

11. The video display array structure of claim 10 wherein the video display unit is an LED display or an LCD display.

12. The video display module of claim 10 wherein the substantially linear member comprises a central portion having a top portion and at least one catch flange extending transversely from the top of the central portion, wherein the at least one catch flange has a lower edge and wherein the plurality of pairs of catches extend outwardly from the lower edge.

13. The video display array structure of claim 10 wherein the first handle is attached by a first two-position hinge operably connected to the first release and the second handle attached by a second two-position hinge operably connected to the second release.

14. The video display array structure of claim 10 wherein the support has is a polygonal shape.

15. The video display array structure of claim 13 wherein the polygonal shape is a rectangle or a square.

16. The video display assembly of claim 15 wherein the first handle and the second handle are attached at the same distance along the first and second opposing sides, respectively.

17. The video display array structure of claim 10 wherein the release includes a trigger release disposed on the handle.

18. The video display array structure of claim 10 further comprising a header to space the splines

19. The video display array structure of claim 10 wherein the splines are of equal length and the pairs of catch members on each of the opposing sides of the splines are spaced the same distance along the length of each spline.

20. The video display array structure of claim 10 wherein the spacing between adjacent pairs of catch members is substantially the same as the height of adjacent video display modules.
